(19) United States
(12) Patent Application Publication
(10) Pub. No.: US 2020/0144836 A1
(43) Pub. Date: May 7, 2020

(54) TRAVEL CASE AND STAND FOR SMART WATCH

(71) Applicant: ANDREW BRADFORD GREEN, MT. PLEASANT, SC (US)

(72) Inventor: ANDREW BRADFORD GREEN, MT. PLEASANT, SC (US)

(21) Appl. No.: 16/736,175

(22) Filed: Jan. 7, 2020

Related U.S. Application Data
(63) Continuation-in-part of application No. 15/447,204, filed on Mar. 2, 2017, now Pat. No. 10,530,176.
(60) Provisional application No. 62/311,437, filed on Mar. 22, 2016.
(60) Provisional application No. 62/302,522, filed on Mar. 2, 2016.

(51) Int. Cl. H02J 7/00; G04G 19/00

(52) U.S. Cl. CPC H02J 7/0044; G04G 19/00

(57) ABSTRACT

A combination case or holder and stand with removable charger for a smart watch. The case includes a top hingedly attached to a bottom, the top with a recharging disk holder with a recharging cord or recharger located in the interior or bottom of the case. The smart watch is laid on top of the case, or the entire case may be inserted into the watch band and secured. The case also may be used with the top open, and the smart watch placed so the case functions as a recharging watch stand.

This application is a continuation in part of U.S. patent application Ser. No. 15/447,204, filed Mar. 2, 2017, which claims benefit of and priority to U.S. Provisional Applications No. 62/302,522, filed Mar. 2, 2016, and No. 62/311,437, filed Mar. 22, 2016, by Andrew B. Green, and is entitled to those filing dates for priority. The specifications, figures, and complete disclosure of U.S. Provisional Applications Nos. 62/302,522 and 62/311,437 and U.S. patent application Ser. No. 15/447,204 are incorporated herein in their entireties by specific reference for all purposes.

### FIELD OF INVENTION

This invention relates generally to a combination case or holder and stand with removable charger for a smart watch.

### BACKGROUND OF THE INVENTION

The proliferation of portable electronic devices and tablet computing devices is well known. Each successive iteration or generation provides increasingly greater features and capabilities, typically through a variety of user-friendly, content-specification applications (or “apps”). One relatively new market segment that has shown exemplary growth is the “smart watch,” such as the Apple Watch.

While smart watches typically are worn on the user's wrist, and thus are convenient for travel, current power consumption for these devices requires frequently (i.e., daily) charging. A travelling user thus must be sure to take a recharging unit with a cord and charging disk, appropriate USB adapters, and other accessors (such as changeable watch bands). These accessories are often forgotten, or if packed, can be easily damaged or lost.

Accordingly, what is needed is a convenient means of storing smart watch accessories that will protect the accessories while allowing full functionality, display and recharge of the smart watch with an aesthetically pleasing and protective appearance.

### SUMMARY OF THE INVENTION

In various exemplary embodiments, the present invention comprises an elongated case with the top hingedly attached to the bottom along one side. In one embodiment, the case is similar in form to a clamshell style case. A clasp (magnetic, mechanical, or similar) along the opposite side may be used to securely close the case

The inside of the top comprises a recharging disk holder, adapted to securely, but removably, hold a recharging disk for a smart watch. In one embodiment, the surface of the top above the charging disk holder is thin, or comprises appropriate material to allow the charging disk to operate with the watch placed on top of the case.

In an alternative embodiment, the holder comprises a hole adapted to receive and hold the charging disk. The hole is sealed with a plug when the disk is not in place. The plug may be removed by pulling on a tab on one side, whereupon the plug hingedly swings open, and the tab can be secured to a post or rod, or the plug inserted into or onto a hole or cavity or other holder, such as a cylindrical holder, on the inside top, which holds the plug securely in place when the recharging disk in in place.

The plug may be hingedly attached to or near the outer rim or circumference of the recharging disk holder or to the cylindrical holder. In several embodiments, the outer rim or circumference comprises a slot or opening adapted to receive the hinge strap of the plug, thereby allowing the hinge strap to lie flat when the plug is in place in the recharging disk holder hole.

The recharging disk holder comprises a cord channel, adapted to receive the recharging cord when placed in the holder and direct the cord along the inside back of the case (i.e., along the hinged side), to a recharging cord holder in the bottom of the case. In one embodiment, the recharging cord holder comprises one or more brackets extending up from the bottom, around which the recharging cord is wrapped.

The brackets of the recharging cord holder may be located at the ends of the bottom, thereby providing a space or one or more compartments in the center of the bracket(s) or between the brackets. These compartments may be used to securely hold a USB power plug/charging unit, a foreign power supply converter (e.g., a UK USB adapter, as shown), and extra watch bands (e.g., sport bands, formal bands, work bands). Other accessories may be stored in the case, and in several embodiments, the case is sized to store the smart watch as well as all accessories.

For recharging, the USB power plug/charging unit is removed and plugged into a power outlet or power supply, with an appropriate length of recharging cord unreeled from the brackets or holder. The recharging cord may be placed or run through in a slot located at one or both ends (or sides) of the case, so that the recharging function can take place while the case is closed. The smart watch is placed over the outside top of the case at the appropriate spot for recharging by the recharging disk, which has been placed in the holder. An indentation or mark may be placed on the top to indicate proper placement of the smart watch if the disk holder does not comprise a hole.

The smart watch may be simply laid on top of the case, or the case may be inserted into the watch band and secured. In several exemplary embodiments, the top may be hinged open (and held open by springs or appropriate hinge mechanism as known in the art), and the watch placed so that the case functions as a recharging watch stand (i.e., visible on a bed stand). The alarm function of the watch can be used, so the watch and case in this configuration act as a portable, recharging traveling alarm.

### BRIEF DESCRIPTION OF THE DRAWINGS

FIG. 1 shows a perspective view of an open device in accordance with an exemplary embodiment of the present invention.

FIG. 2 shows another perspective view of the device of FIG. 1 in watch stand configuration.

FIG. 3 shows a top view of the device of FIG. 1 in closed position.

FIG. 4 shows a perspective view of the device of FIG. 1 with the recharging disk plugged in.

FIG. 5 shows another perspective view of the device of FIG. 1 with the recharging disk plugged in.

FIG. 6 shows a close up view of a plug in place in the recharging disk holder.

FIG. 7 shows a perspective view of the device of FIG. 6.

FIG. 8 shows a close up view of the plug of FIG. 6 removed from the recharging disk holder and inserted over the holding cylinder.

FIG. 9 shows a perspective view of the device of FIG. 8.

### DETAILED DESCRIPTION OF EXEMPLARY EMBODIMENTS

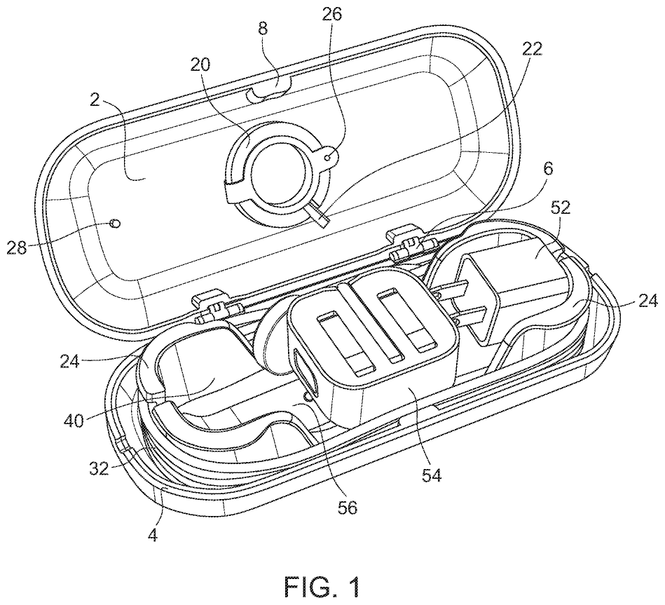

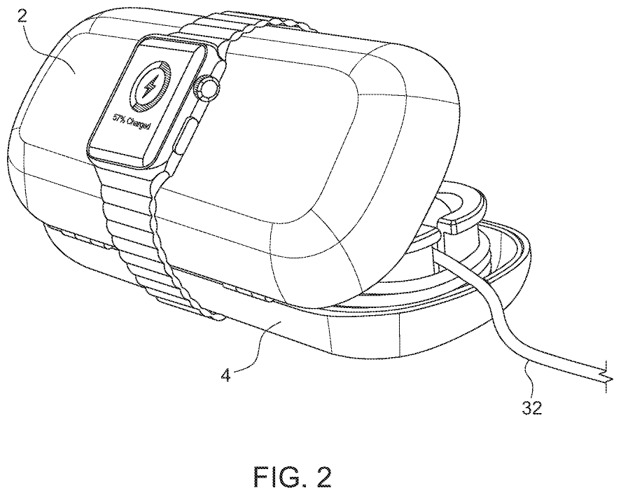

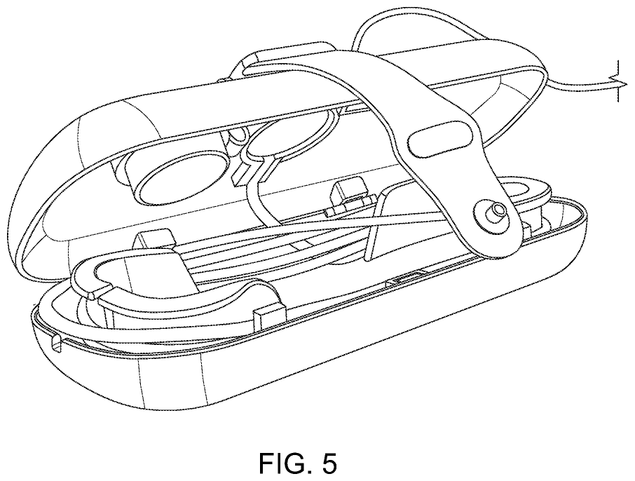

In various exemplary embodiments, as described herein, and as seen in FIGS. 1-5, the present invention comprises an elongated case with a top 2 and a bottom 4, with the top hingedly 6 attached to the bottom along one side. In one embodiment, the case is similar in form to a clamshell style case. A clasp 8 (magnetic, mechanical, or similar) along the opposite side may be used to securely close the case As seen in FIGS. 1-4, the ends and edges of the case may be rounded or smoothed. The top and bottom may be rigid or semi-rigid, and made of a material with a variety of finishes.

The inside of the top comprises a recharging disk holder 20, adapted to securely, but removably, hold a recharging disk 30 for the smart watch. In one embodiment, the surface of the top above the charging disk holder is thin, or comprises appropriate material to allow the charging disk to operate with the watch placed on top of the case. In an alternative embodiment, the holder comprises a hole adapted to receive and hold the charging disk. The hole is sealed with a plug 26 when the disk is not in place. The plug may be removed by pulling on a tab on one side, whereupon the plug hingedly swings open, and the tab can be secured to a post or rod 28, or the plug inserted into or onto a hole or cavity or other holder, such as a cylindrical holder 28a, on the inside top, which holds the plug securely in place when the recharging disk in in place.

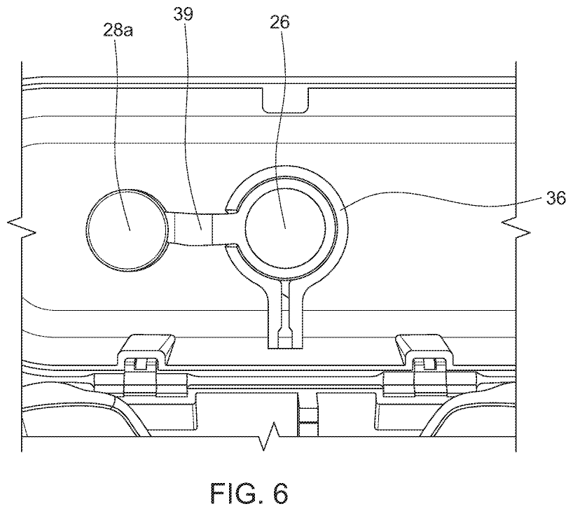

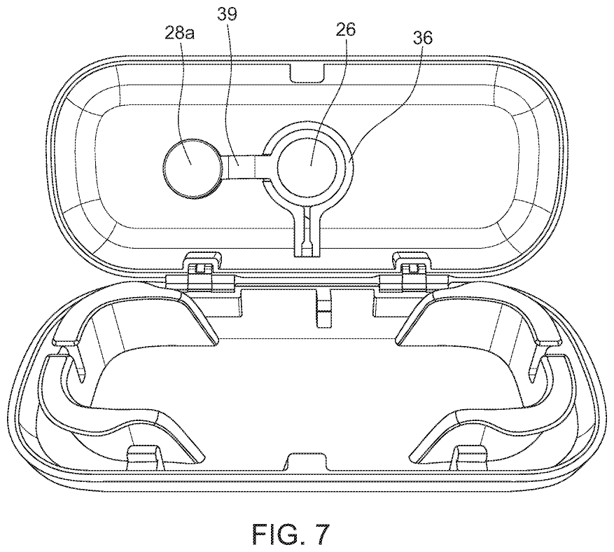

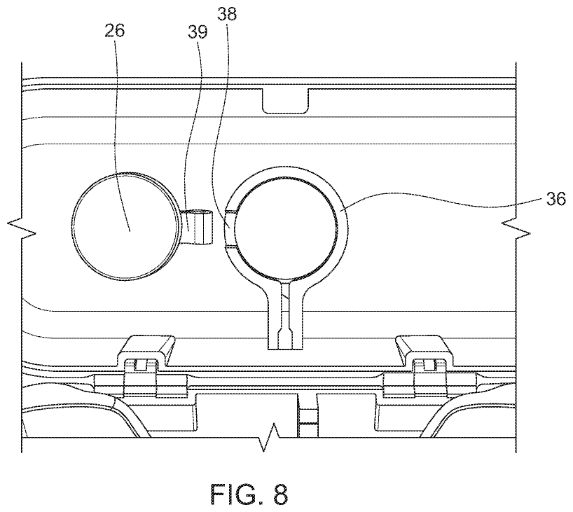

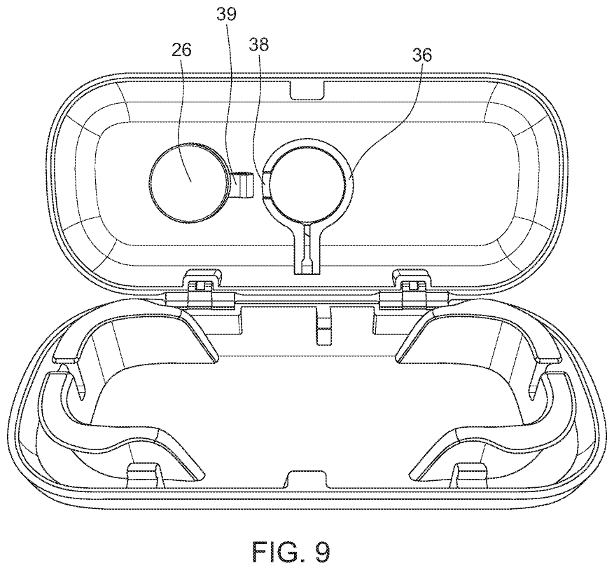

The plug 26 may be hingedly attached to or near the outer rim or circumference 36 of the recharging disk holder, as seen in FIG. 1, or to the cylindrical holder, as seen in FIGS. 6-9. In several embodiments, as seen in FIGS. 6-9, the outer rim or circumference 36 comprises a slot or opening 38 adapted to receive the hinge strap 39 of the plug 26, thereby allowing the hinge strap to lie flat when the plug is in place in the recharging disk holder hole.

The recharging disk holder comprises a cord channel 22, adapted to receive the recharging cord 32 when placed in the holder and direct the cord along the inside back of the case (i.e., along the hinged side), to a recharging cord holder 24 in the bottom of the case. In one embodiment, the recharging cord holder comprises one or more brackets extending up from the bottom, around which the recharging cord 32 is wrapped.

The brackets of the recharging cord holder may be located at the ends of the bottom, thereby providing a space or one or more compartments 40 in the center of the bracket(s) or between the brackets. These compartments may be used to securely hold a USB power plug or charging unit 52, a foreign power supply converter (e.g., a UK USB adapter, as shown) 54, and extra watch bands 56 (e.g., sport bands, formal bands, work bands). Other accessories may be stored in the case, and in several embodiments, the case is sized to store the smart watch as well as all accessories.

For recharging, the USB power plug/charging unit is removed and plugged into a power outlet or power supply, with an appropriate length of recharging cord unreeled from the brackets or holder. The recharging cord may be placed or run through in a slot 34 located at one or both ends (or sides) of the case, so that the recharging function can take place while the case is closed. The smart watch is placed over the outside top of the case at the appropriate spot for recharging by the recharging disk, which has been placed in the holder. An indentation or mark may be placed on the top to indicate proper placement of the smart watch if the disk holder does not comprise a hole.

In other embodiments, the USB charging unit may comprise a USB battery or battery charger, which may be removable from the case. The recharging cord may be plugged into the USB battery or battery charger while in the case, thereby leaving the recharging cord entirely inside the case. This case thus becomes a wireless charging station without the need for an external power supply or power outlet, providing functionality in situations where a power outlet may not be readily available, or the power outlet may not be compatible (e.g., an international power outlet without a power converter).

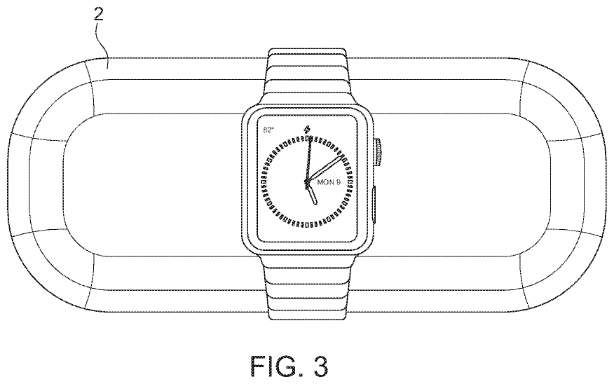

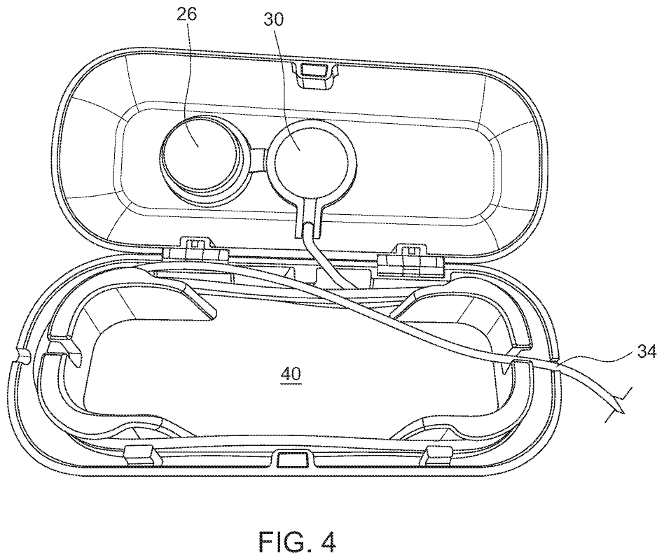

The smart watch may be simply laid on top of the case, or the case may be inserted into the watch band and secured, as seen in FIGS. 3 and 4. In several exemplary embodiments, the top may be hinged open (and held open by springs or appropriate hinge mechanism as known in the art), and the watch placed so that the case functions as a recharging watch stand (i.e., visible on a bed stand). The alarm function of the watch can be used, so the watch and case in this configuration act as a portable, recharging traveling alarm.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A smart watch case, comprising:
a top hingedly attached to a bottom, the top with an exterior side and an interior side;
a recharging disk holder on the interior side of the top, configured to securely hold a smart watch recharging disk; and
a rechargeable battery disposed inside the case.

2. The case of claim 1, further comprising a hole in the top of the case above the recharging disk holder.

3. The case of claim 2, further comprising a removable plug configured to seal the hole when a recharging disk is not in place in the recharging disk holder.

4. The case of claim 1, further comprising:
a recharging cord holder in the bottom of the case; and
a recharging cord channel on the interior side of the top, adapted to hold a recharging cord extending from recharging disk holder to the recharging cord holder.

5. The case of claim 4, wherein the recharging cold holder comprises a pair of brackets with one or more compartments in the bottom therebetween.

6. The case of claim 5, wherein said one or more compartments comprises a charging unit compartment.

7. The case of claim 1, wherein the top and bottom are elongated.

8. The case of claim 1, comprising three use configurations when a recharging disk has been inserted into the recharging disk holder:
a first use configuration where the case is closed, and a smart watch is laid upon the top of the case with the smart watch positioned directly above the recharging disk holder;
a second use configuration where the case is closed and inserted into a watch band of a smart watch with the smart watch positioned directly above the recharging disk holder;
a third use configuration where the case is open with the top at an angle to the bottom, and a smart watch is laid upon the angled top with the smart watch positioned directly above the recharging disk holder.

9. The case of claim 1, further wherein the top above the recharging disk holder is thin in thickness.

10. The case of claim 9, further comprising a placement mark or indentation on the exterior side of the top above the recharging disk.

11. The case of claim 1, wherein the rechargeable battery comprises a USB battery or battery charger.

12. The case of claim 1, wherein the rechargeable battery is removable.
